(19) United States
(12) Patent Application Publication
(10) Pub. No.: US 2005/0284305 A1
(43) Pub. Date: Dec. 29, 2005

(54) Pressure cooker with a lid having moving jaws

(75) Inventor: Laurian Angue, Chateauroux (FR)

Correspondence Address: YOUNG & THOMPSON, 745 SOUTH 23RD STREET, 2ND FLOOR, ARLINGTON, VA, 22202, US

(73) Assignee: SOCIETE INDUSTRIELLE DE TRANSFORMATION DE METAUX SITRAM

(21) Appl. No.: 11/159,214

(22) Filed: Jun. 23, 2005

(30) Foreign Application Priority Data
Jun. 29, 2004 (FR) 04 07173

(51) Int. Cl. A23L 1/00

(52) U.S. Cl. 99/337

(57) ABSTRACT

A pressure cooker includes a bowl and a removable lid carrying at least two jaws mounted to move on the lid between a locking position for locking the lid on the bowl and an unlocking position, each jaw being connected to a slider mounted to slide on the lid so that sliding of the slider causes the associated jaw to move towards one of the positions. A pinion is mounted to turn on the lid about an axis that is vertical in operation, each slider having a rack-forming toothed portion which co-operates with the pinion so that turning the pinion causes all of the jaws to move simultaneously towards one of the positions.

The invention relates to a pressure cooker with a lid having moving jaws.

### BACKGROUND OF THE INVENTION

Pressure cookers are known, e.g. from document EP 0 691 096, that comprise a bowl and a removable lid having two jaws mounted to move between a position for locking onto the bowl and an unlocking position, the jaws being secured to sliders mounted to slide on the lid parallel to each other.

On the above-mentioned pressure cooker lid, a knob drives a central crank-forming bar which is mounted to turn on the lid and which is connected to the sliders by connecting rods, such that turning the knob causes the jaws to move in opposite directions.

That jaw-actuating mechanism includes numerous hinges, thereby making it complex to manufacture and assemble.

Document EP 1 139 828 discloses a pressure cooker having a single moving jaw connected to a slider mounted to slide on the lid. The slider has a toothed end forming a rack which co-operates with a toothed sector of a handle mounted to turn on the lid about an axis that is horizontal in operation.

### OBJECT OF THE INVENTION

An object of the invention is to provide a pressure cooker having a lid with at least two moving jaws, and an actuator mechanism that is particularly simple.

### BRIEF DESCRIPTION OF THE INVENTION

To this end, the invention provides a pressure cooker comprising a bowl and a removable lid carrying at least two jaws mounted to move on the lid between a locking position for locking the lid on the bowl and an unlocking position, each jaw being connected to a slider mounted to slide on the lid so that sliding of the slider causes the associated jaw to move towards one of said positions, in which, according to the invention, a pinion is mounted to turn on the lid about an axis that is vertical in operation, each slider having a rack-forming toothed portion which co-operates with said pinion so that turning the pinion causes all of the jaws to move simultaneously towards one of said positions.

Thus, the rack system which is known for actuating a single jaw has been modified in the invention to allow at least two jaws to be driven simultaneously. The disposition of the pinion mounted to turn about a vertical axis makes its side surface accessible on all sides, thereby enabling the pinion to co-operate with a plurality of racks. The actuator mechanism of the invention is much simpler than the crank and connecting rod mechanism of the prior art.

### BRIEF DESCRIPTION OF THE DRAWINGS

The invention will be better understood in the light of the following description given reference to the figures of the accompanying drawings, in which:

FIG. 1 is a perspective view of a pressure cooker provided with a lid in a first particular embodiment of the invention;

FIG. 2 is a perspective view of the FIG. 1 lid, with a cover for protecting the actuator mechanism omitted;

FIG. 3 shows the lid in section on line III-III of FIG. 1;

FIG. 4 is a fragmentary section view on line IV-IV of FIG. 3;

FIG. 5 is a fragmentary section view on line V-V of FIG. 3;

FIG. 6 is a view from beneath of the actuator mechanism drive knob;

FIG. 7 is a fragmentary plan view of a lid in a second particular embodiment of the invention; and

FIG. 8 is a fragmentary section view of a lid in a third particular embodiment of the invention.

### DETAILED DESCRIPTION OF THE INVENTION

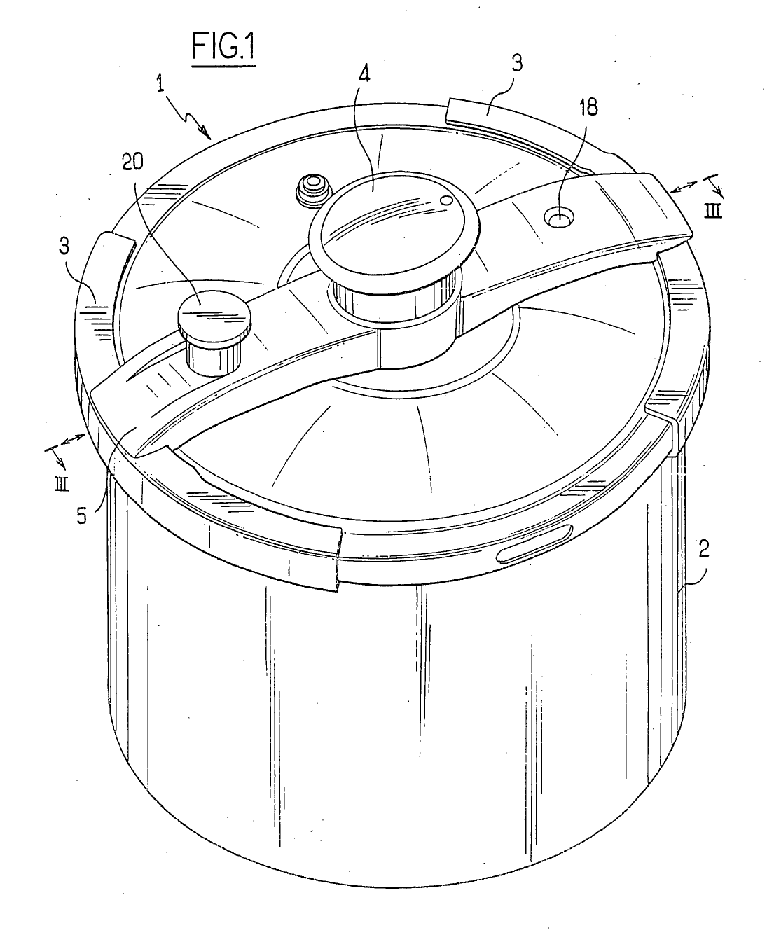

With reference to FIG. 1, the lid 1 of the invention serves to close a bowl 2 of a pressure cooker. To do this, and in a first particular embodiment of the invention, the lid 1 has two jaws 3 that are radially movable (as shown by the arrows) between a position for locking onto the bowl 2, as shown, in which the jaws are engaged on an edge of the bowl, and an unlocking position in which the jaws are spaced apart from the bowl 2.

The lid 1 includes a drive knob 4 pivotally mounted about an axis Z that is vertical in operation, and coinciding in this case with an axis of circular symmetry of the lid. The drive knob 4 is associated with a mechanism for actuating the jaws 3, which mechanism is hidden under a cover 5.

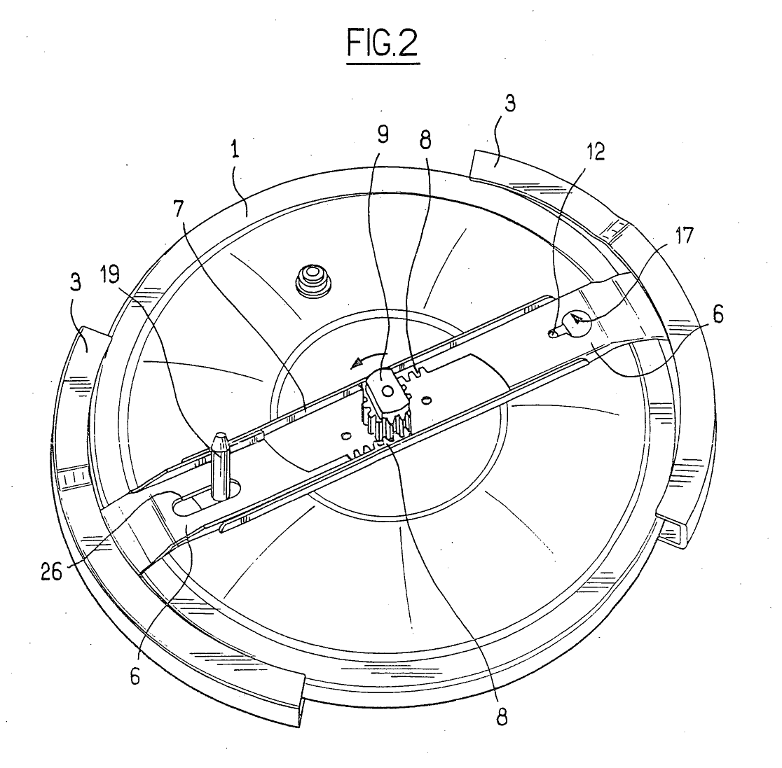

As can be seen in FIG. 2, where the cover 5 has been omitted, the jaws 3 are secured to sliders 6 that are slidably mounted in a slideway 7 fitted onto the lid 1.

The sliders 6 have ends 8 presenting rack-forming teeth. Said ends 8 extend on either side of a pinion 9 mounted to turn about the axis Z on the bottom of the slideway 7. The pinion 9 co-operates with the ends 8 of the sliders 6 so that turning the knob 9 causes the jaws 3 to move in opposite directions. The drive knob 4 (not shown in this figure) is naturally secured to the pinion 9.

In FIG. 2, the jaws 3 are shown in the unlocking position. Turning the pinion 9 through one-fourth of a turn in the direction indicated by the arrow suffices to bring the jaws 3 into the locking position.

As can be see in FIG. 3, the lid 1 comprises a stamped wall 10 that presents a central indentation 11, with the slideway 7 extending on the wall 10 on either side of the central indentation 11.

The lid 1 includes a pressure indicator 12 slidably mounted in a guide 13 which extends through the wall 10 of the lid 1 and through the bottom of the slideway 7. The guide 13 includes a shoulder 14 and a threaded portion 15 engaged in a tapped orifice 16 in the bottom of the slideway 7, such that the wall 10 of the lid is clamped between the shoulder 14 and the slideway 7.

The slider 6 which extends beside the pressure indicator 12 (referred to below as the slider 6a) includes an orifice 17 which is aligned with the pressure indicator 12 only when the associated jaw is in the locking position.

The orifice 17 is clearly visible in FIG. 2, where the end of the pressure indicator 12 can be seen. In this figure the orifice 17 is not in alignment with the pressure indicator 12 since the jaws are in the unlocking position.

An orifice 18 formed through the cover 5 in register with the pressure indicator enables it to be seen from the outside. If the end of the pressure indicator 12 is visible through the orifice 18, then the orifice 17 of the slider 6a is in alignment with the pressure indicator 12, and thus the jaws are in the locking position.

Under the effect of the pressure that exists inside the bowl (which pressure cannot become established unless the jaws are in the locking position), the pressure indicator 12 is moved towards a high position (as shown) in which it extends through the orifice 17 of the slider 6a, thereby blocking the jaw actuator mechanism and preventing the lid being opened while the bowl is under pressure. The pressure indicator 12 thus also performs a function of locking the actuator mechanism in the locking position. In this respect, it should be observed that the pressure indicator co-operates with only one of the sliders, which suffices to block the entire actuator mechanism.

In FIG. 4, it can be seen that the slider 6a co-operating with the pressure indicator 12 has a channel section in the form of an upside-down U-shape. The flanges of the channel section co-operate with the slideway 7 to guide the slider 6a, while the web of the slider is held above the bottom of the slideway 7 so that when the pressure indicator 12 is in its rest position, as shown in this figure, the slider 6a is free to slide.

The lid 1 further includes an exhaust duct 19 which likewise extends through the wall 10 of the lid 1 and through the bottom of the slideway 7. The exhaust duct 19 includes a shoulder 22 and a threaded portion 23 which receives a nut 24 (provided with a strainer 25) so that the wall 10 and the bottom of the slideway 7 are clamped together between the shoulder 22 and the nut 24. The exhaust duct 19 is designed to receive a weight 20 (visible in FIG. 1) for regulating pressure via a needle valve that enables the pressure inside the bowl to be maintained at a predetermined threshold.

In order to allow the adjacent slider 6 (referenced below as 6b) to move freely, this slider has an oblong slot 26 through which the exhaust duct 19 extends. The slot 26 is clearly visible in FIG. 2. In FIG. 5, it can be seen that the slider 6b is of channel section of right-way-up U-shape with flanges co-operating with the slideway 7 to guide the slider 6b.

According to a particular aspect of the invention, the pinion 9 comprises a core 30 having teeth 31 formed thereon. The core 30 has a top portion 32 with two flats (clearly visible in FIG. 2. This top portion is engaged in a cavity complementary to the knob 4 with which it co-operates for ensuring that the knob 4 is angularly constrained relative to the pinion 9. A screw 33 holds the knob 4 on the pinion 9.

The core 30 has a circular bottom portion 34 which extends through a central orifice in the slideway 7. A washer 35 is welded to said bottom portion 34 so that the slideway 7 is held captive between the bottom flanks of the teeth 31 and the washer 53. The pinion 9 is thus secured to the slideway 7 while being free to turn.

It should be observed that the washer 35 extends under the slideway 7 in register with the indentation 11 in the wall 10 of the lid 1, so that the washer 35 does not interfere with the slideway 7 being mounted on the lid 1.

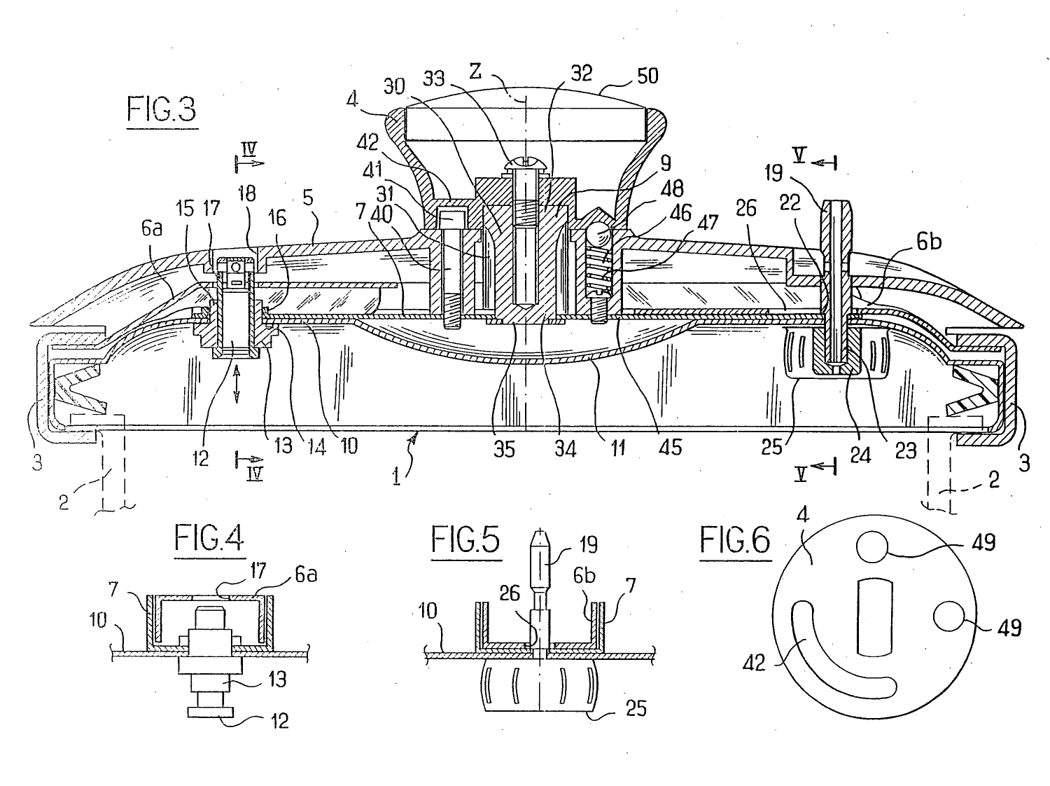

According to another aspect of the invention, the cover 5 is secured to the slideway 7 via a first fastening screw 40 having a head 41 that projects from a top face of the cover 5. Said head 41 forms a stud that is engaged in an annular groove 42 in the knob 4, as can be seen more clearly in FIG. 6. The annular groove 42 extends over an angle of 90°, so that co-operation between the head 41 and the annular groove 42 restricts the turning range of the knob 4, and thus of the pinion 9, to one-fourth of a turn.

According to yet another aspect of the invention, the cover 5 is connected to the slideway 7 by a second fastener screw 45 that extends from the bottom of a housing 46 formed in the cover 5. This housing receives a spring 47 and a ball 48. The ball is thus pressed against the bottom face of the knob 4 so as to be selectively engaged in one or the other of two dimples 49 formed in said bottom face and visible in FIG. 6. The ball 48 thus indexes the knob in two angular positions corresponding respectively to the locking position and to the unlocking position of the jaws.

Thus, the members for fastening the cover 5 on the slideway 7 (the head of one of the screws, the housing for the other screw) are also used to perform the functions of limiting the angular stroke and of indexing the position of the drive knob 4.

Said fastener members are hidden by the knob 4, thereby improving the appearance of the lid. To gain access to said fastener member, it is necessary to unscrew the screw 33 for holding the knob 4 on the pinion 9, by removing a cap 50 on the knob 4 which hides said screw. It should be observed that the fastener screws 40, 45 project a little way beneath the slideway 7 over the indentation 11 in the wall 10 of the lid 1, so that this projection does not interfere with the slideway 10 being mounted on the lid 1.

It should also be observed that in the embodiment shown herein, the slideway 7 is the only element of the entire jaw actuator mechanism that is fastened to the lid 1, with all of the other elements being guided by the slideway 7 (sliders 6) or secured to the slideway 7 (the assembly comprising the pinion 9 and the knob 4, the cover 5). The slideway 7 is held in place on the lid by the supports for the safety members (locking indicator guide, exhaust duct of the regulator valve). This retention is thus formed in a manner that is particularly simple without having recourse to any welding of the slideway onto the lid, or indeed without any holes being drilled for passing fastener screws through the wall 10, which would lead to leakage problems.

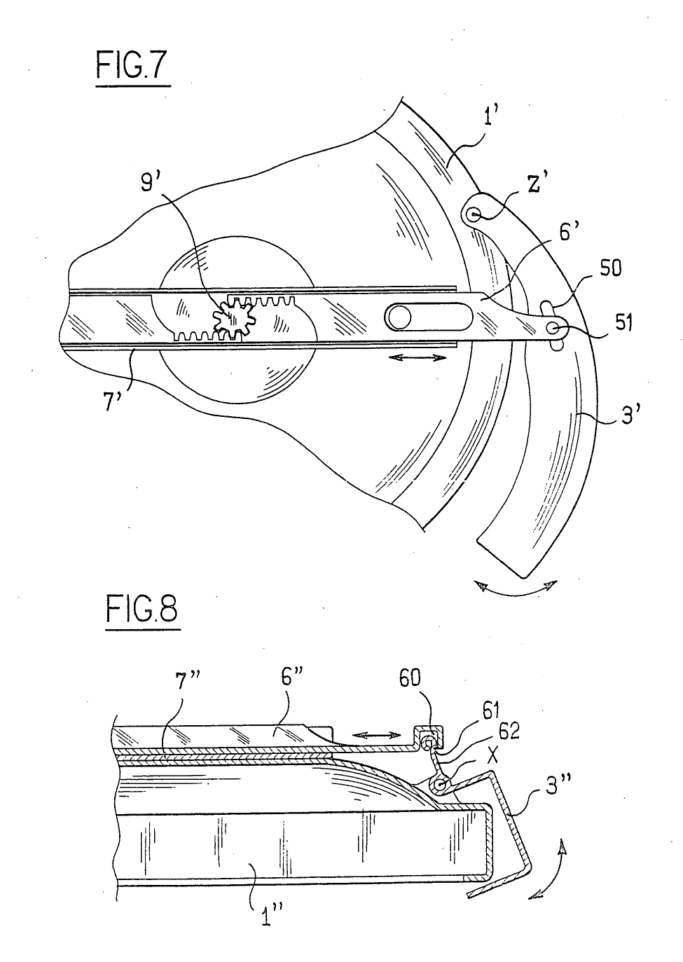

In a second particular embodiment of the invention as shown in FIG. 7, the jaws 3′ (shown in the unlocking position) are hinged to the lid 1 about respective axes Z′ that are vertical in operation (visible end-on in FIG. 7). Each jaw 3′ includes a slot 50 in which a finger 51 carried by the adjacent slider 6′ is engaged, such that sliding the slider 6′ causes the associated jaw 3′ to pivot.

In a third particular embodiment of the invention, as shown in FIG. 8, the jaws 3″ are hinged to the lid 1″ about respective axes X that are horizontal in service (seen end-on in FIG. 8). The sliders 6″ are terminated by respective housings 60 which receive the end of a corresponding finger 62 secured to the associated jaw, such that sliding the slider 6″ causes the associated jaw 3″ to rock. It should be observed that in this particular embodiment, and unlike the other two embodiments shown, bringing the jaws into the locking position requires the sliders 6″ to be slid outwards.

The invention is not limited to the particular embodiments described above, but on the contrary covers any variant coming within the ambit of the invention as defined by the claims.

In particular, although it is stated that the sliders extend in a slideway that is fitted onto the lid, the slideways could slide directly on a portion of the wall of the lid, in which the sliders would be guided by flanks formed either in the wall of the lid, or in the cover for protecting the jaw actuator mechanism. The pinion could then be mounted to turn either on the wall of the cover (providing adequate leaktightness is provided between said wall and the pinion), or else on the protective cover.

Although it is stated that the pinion is actuated by a rotary knob connected directly to the pinion, any other way of actuating the pinion could be provided, such as, for example, a knob that moves radially and that is connected to a rack that co-operates with the pinion, or indeed a lever having an axis that is horizontal in operation and that is connected to the pinion by bevel gears.

Although the pinion is shown as being toothed all around its periphery, the pinion need only have teeth occupying sectors of sufficient angular extent to enable the jaws to be moved between the locking position and the unlocking position.

Although the lid of the invention is shown as having two jaws, the lid could have more than two jaws. In particular, the lid could have four jaws that are regularly spaced apart, with the associated sliders being mounted in two slideways extending at right angles to each other. Each slider could also be associated with a specific slideway, in particular when there are an odd number of jaws. The sliders do not necessarily extend in radial directions, providing that sliding of the sliders causes the associated jaws to move towards a locking position or an unlocking position.

1. A pressure cooker comprising a bowl and a removable lid carrying at least two jaws mounted to move on the lid between a locking position for locking the lid on the bowl and an unlocking position, each jaw being connected to a slider mounted to slide on the lid so that sliding of the slider causes the associated jaw to move towards one of said positions, wherein a pinion is mounted to turn on the lid about an axis that is vertical in operation, each slider having a rack-forming toothed portion which co-operates with said pinion so that turning the pinion causes all of the jaws to move simultaneously towards one of said positions.

2. A pressure cooker according to claim 1, wherein at least one slider extends in a slideway fitted to the lid.

3. A pressure cooker according to claim 2, wherein the lid includes at least two safety members having supports extending through the lid, the supports being arranged so as to hold the slideway in position against the lid.

4. A pressure cooker according to claim 2, wherein the pinion is mounted to turn on a bottom of the slideway.

5. A pressure cooker according to claim 4, wherein the pinion comprises a core presenting teeth and a circular portion passing through the bottom of the slideway, a washer being fitted to the end of the circular portion so that the bottom of the slideway is held captive between the teeth and the washer.

6. A pressure cooker according to claim 1, wherein the pinion is associated with a dive knob, the lid including a cover covering the slideway from which there extends a stud for penetrating into an annular groove in the drive knob, which groove occupies an arc.

7. A pressure cooker according to claim 6, wherein the stud is constituted by the end of a fastener screw for fastening the cover to the slideway.

8. A pressure cooker according to claim 1, wherein the pinion is associated with a drive knob and wherein the lid includes a cover covering the slideway and including a housing for a spring and a ball, the knob including dimples into which the ball penetrates selectively under drive from the spring when the ball is in register with one of the dimples.

9. A pressure cooker according to claim 8, wherein the housing for the spring and the ball is constituted by a portion of an orifice for passing a fastener screw for fastening the cover to the slideway.

10. A pressure cooker according to claim 1, wherein each jaw is connected rigidly to the associated slider so that the jaw slides together with the slider.
